(19) United States
(12) Patent Application Publication
(10) Pub. No.: US 2009/0179076 A1
(43) Pub. Date: Jul. 16, 2009

(54) On-line bar-coded ticket for transient parking, which requires a server connection only at either entrance or exit, but not both

(75) Inventor: Brian T. McGann, Minneapolis, MN (US)

Correspondence Address: CHARLES E. BAXLEY, ESQUIRE, 90 JOHN STREET, SUITE 309, NEW YORK, NY, 10038, US

(73) Assignee: Amano McGann, Inc.

(21) Appl. No.: 12/008,286

(22) Filed: Jan. 10, 2008

(51) Int. Cl. G07B 15/04; G07B 15/02

(52) U.S. Cl. 235/384; 705/13

(57) ABSTRACT

An on-site system for calculating a transient parking fee. The system includes a ticket and a machine-readable storage device. The machine-readable storage device is disposed on, and is machine-readable from, the ticket, contains data necessary to compute the transient parking fee at exit of the transient parking without any further need to utilize a rate calculation engine, and is a bar code. A server communicates a rate structure to the machine-readable storage device, and looks forward from an entrance date and time to determine breakpoint times by minutes where there is a change in a fee and then encodes that data onto the machine-readable storage device on the ticket. Only either an entrance device or an exit device must be on-line, but not both.

### 1. BACKGROUND OF THE INVENTION

A. Field of the Invention

The embodiments of the present invention relate to a ticket for transient parking, and more particularly, the embodiments of the present invention relate to an on-line bar-coded ticket for transient parking, which requires a server connection only at either entrance or exit, but not both.

B. Description of the Prior Art

A traditional transient parking system issues to each incoming patron a ticket having the entrance date and time printed and encoded onto a magnetic stripe or bar code. An on-line transient parking system deviates somewhat by issuing and storing ticket numbers from a central server allowing entrance and exit devices to be simpler and less costly, but also making proper operation dependent upon the server and network.

Thus, there exists a need for a system combining the robustness of a traditional system with the simplicity, lower cost, and reduced maintenance of an on-line system.

Numerous innovations for ticket-related devices have been provided in the prior art, which will be described below in chronological order to show advancement in the art, and which are incorporated herein by reference thereto. Even though these innovations may be suitable for the specific individual purposes to which they address, however, they differ from the embodiments of the present invention in that they do not teach an on-line bar-coded ticket for transient parking, which requires a server connection only at either entrance or exit, but not both.

(1) U.S. Pat. No. 4,555,618 to Riskin.

U.S. Pat. No. 4,555,618 issued to Riskin on Nov. 26, 1985 in class 235 and subclass 384 teaches a system for facilitating collection of tolls on highways, which includes a provision of exteriorly visible bar codes or other machine-readable customer-account identifications on vehicles using toll roads. Issuance of the account identification elements enables the customer to pass assigned scanning locations where the elements are machine-read and verified at a computerized station serving a selected number of scanning locations. Through a computerized network, the scanned data is ultimately transmitted to credit-issuing companies for billing to the customers who have used the machine-readable elements. The system permits a vehicle to continue past the scan point without stopping, thus offering maximum convenience to motorists, speeding up flow of traffic, and reducing number of personnel required at highway toll plazas.

(2) U.S. Pat. No. 5,598,477 to Berson.

U.S. Pat. No. 5,598,477 issued to Berson on Jan. 28, 1997 in class 380 and subclass 51 teaches a system and method for issuing and validating tickets. The system includes a data processing system for receiving ticket request information and generating ticket information. The ticket information includes encrypted validating information. A local printing system receives the ticket information and prints the encrypted validating information on a ticket in machine-readable format, and a validating system for converting the encrypted validating information into a digital format, decrypting the validating information, testing the validating information to validate the ticket, and if the ticket is valid, downloading at least a portion of the ticket information for reconciliation of accounts for reconciling ticket issuance, use, and payment. The data processing system receives an itinerary from a purchaser, checks a reservation system to determine service availability, and provides service availability information to the purchaser who selects appropriate services and submits ticket request information. The data processing system then generates ticket information including encrypted validating information and transmits the ticket information to the local printing system, which prints a ticket having the encrypted validating information printed in a machine-readable format. When the ticket is presented to a validating system, the validating system converts the encrypted validating information into a digital format, decrypts the encrypted validating information, tests the validating information to validate the ticket, and if the ticket is valid, downloads at least a portion of the ticket information for reconciliation of accounts for reconciliation of ticket issuance, use, and payment. A number of encryption protocols for encryption of the validating information are also taught.

(3) U.S. Pat. No. 6,454,174 to Sansone.

U.S. Pat. No. 6,454,174 issued to Sansone on Sep. 24, 2002 in class 235 and subclass 494 teaches a number identifying a purchaser of a ticket based upon information obtained about the purchaser and the purchaser's computer system during the purchase of the ticket. The system will produce an additional unique number that may take the form of a bar code that is printed on the ticket during the production of the ticket. The bar code may be encrypted and related to the printer that printed the ticket. A reader at the location that the ticket is presented for the purchaser's entrance reads the bar code containing information about the printer that printed the ticket and verifies the information contained in the bar code.

(4) U.S. Pat. No. 6,505,774 to Fulcher et al.

U.S. Pat. No. 6,505,774 issued to Fulcher et al. on Jan. 14, 2003 in class 235 and subclass 381 teaches an automated fee collection and ticket dispensing machine capable of operating under a variety of operating modes. The machine permits users to purchase a variety of passes. The machine includes printers to produce receipts or passes for services or activities. These receipts and passes may be printed for each specific user, and may feature a machine-readable bar code. The machine also includes a bar code reader allowing users to return printed receipts or passes at the machine and to receive credit for any unused portion. Payment may be made using credit cards, debit cards, or cash. The device is provided with networking apparatus to allow central control and monitoring of the device. Power for the machine may be provided by hard-wiring the device to conventional AC power lines, by solar panels, by batteries, or a combination of any of these. Power consumption is held to a minimum by providing a “sleep” mode. The user interface includes a video output screen with “touch screen” capability to receive user input, audio output apparatus, and a proximity sensor to activate the machine when a user approaches. Additionally, security apparatus is provided to deter potential thieves or vandals.

### (5) United States Patent Application Publication Number 2005/0178840 to Chang et al.

United States Patent Application Publication Number 2005/0178840 published to Chang et al. on Aug. 18, 2005 in class 235 and subclass 462.14 teaches an automatic scanning device for automatically scanning bar codes attached on products conveyed on production lines, which includes a sensor, two bar code readers, an alert lamp, a buzzer, a halt switch, and a hand-held scanner. The sensor is used for detecting whether there are products passing through the automatic scanning device. The bar code readers are used for automatically scanning bar codes attached on products when the sensor detects products. The alert lamp and the buzzer are used for timely notifying an operator, the halt switch is used for halting an associated production line or part thereof, and the hand-held scanner is used for scanning the bar codes by hand when the bar code readers fail to scan the bar codes. A related method is also taught.

(6) U.S. Pat. No. 7,017,806 to Peterson.

U.S. Pat. No. 7,017,806 issued to Peterson on Mar. 28, 2006 in class 235 and subclass 384 teaches a method for receiving a data stream of an airline ticketing reservations computer, striping-away data bits included for the ordering and identifying and reading and writing of the data stream on magnetic media, and selecting and converting the remaining data into multi-dimensional symbology or bar code for printing onto airline ticket and/or boarding documents.

(7) U.S. Pat. No. 7,044,362 to Yu.

U.S. Pat. No. 7,044,362 issued to Yu on May 16, 2006 in class 235 and subclass 375 teaches a method and system for electronic ticket recognition and acceptance. The method includes the step of facilitating a purchase of an electronic ticket from a networked ticketing computer. Another step is downloading the electronic ticket to a portable computing device having a data output. An additional step is enabling activation of the electronic ticket to communicate the electronic ticket via the data output, allowing the displayed electronic ticket to be optically communicated to a ticket receiving unit.

(8) U.S. Pat. No. 7,181,426 to Dutta.

U.S. Pat. No. 7,181,426 issued to Dutta on Feb. 20, 2007 in class 705 and subclass 37 teaches a computer-driven reservation system for reserving spaces in a parking facility at an airport terminal. The reservation system includes a central server, a database of locations and associated plurality of spaces that may be reserved for customer use, and one or more customer terminals on which is displayed a graphical user interface (GUI) for receiving a customer's reservation request and enabling other customer interactions. The central server, database, and customer terminals are interlinked via a network. The central server includes a reservation utility providing a reservation GUI and a printable reservation coupon with reservation information when a space is reserved. In one embodiment, the central server includes an auction utility monitoring the number of spaces available in a particular location, and when the number falls below a predetermined number, implements an auction procedure for all of the remaining number of spaces. Each remaining space is then allocated to a highest bidder.

It is apparent that numerous innovations for ticket-related devices have been provided in the prior art that are adapted to be used. Furthermore, even though these innovations may be suitable for the specific individual purposes to which they address, however, they would not be suitable for the purposes of the embodiments of the present invention as heretofore described, namely, an on-line bar-coded ticket for transient parking, which requires a server connection only at either entrance or exit, but not both.

### 2. SUMMARY OF THE INVENTION

Thus, an object of the embodiments of the present invention is to provide an on-line bar-coded ticket for transient parking, which requires a server connection only at either entrance or exit, but not both, which avoids the disadvantages of the prior art.

Briefly stated, another object of the embodiments of the present invention is to provide an on-site system for calculating a transient parking fee. The system includes a ticket and a machine-readable storage device. The machine-readable storage device is disposed on, and is machine-readable from, the ticket, contains data necessary to compute the transient parking fee at exit of the transient parking without any further need to utilize a rate calculation engine, and is a bar code. A server communicates a rate structure to the machine-readable storage device, and looks forward from an entrance date and time to determine breakpoint times by minutes where there is a change in a fee and then encodes that data onto the machine-readable storage device on the ticket. Only either an entrance device or an exit device must be on-line, but not both.

The novel features considered characteristic of the embodiments of the present invention are set forth in the appended claims. The embodiments of the present invention themselves, however, both as to their construction and their method of operation together with additional objects and advantages thereof will be best understood from the following description of the specific embodiments when read and understood.

### 3. DETAILED DESCRIPTION OF THE PREFERRED EMBODIMENTS

### A. The Embodiments of the Present Invention

The on-line bar-coded ticket of the embodiments of the present invention utilizes advances in bar code technology to create a transient parking ticket, which from the moment it is issued, contains information necessary to compute the fee at exit without any further need to utilize a rate calculation engine. The server “looks forward” from the current date/time to determine the breakpoint times by minutes where there is a change in fee and then encodes that data using two-dimensional bar code onto each ticket.

### B. An Example of the Embodiments of the Present Invention

RATE STRUCTURE

```
15 minute grace period
  $8.00 first hour
  $5.00 each additional hour
$25.00 daily maximum
```

Using the rate structure above, a ticket issued on Aug. 17, 2007 at 9:10 AM would have bar code encoded thereon the following information:

| | | VALUE (15-BYTES |
|---|---|---|
| DATE | TIME | UNCOMPRESSED) |
| 2007-08-17 | 09:10 | 000.00 |
| 2007-08-17 | 09:25 | 000.00 |
| 2007-08-17 | 10:25 | 008.00 |
| 2007-08-17 | 11:25 | 013.00 |
| 2007-08-17 | 12:25 | 018.00 |
| 2007-08-17 | 1:25 | 023.00 |
| 2007-08-17 | 2:25 | 025.00 |

This example is relatively simple, but any conceivable rate structure including early-bird, night-rates, weekend rates, etc. can be accommodated using current rate computing technology. Server software could use brute-force methods, i.e., once per minute run a given period of forward-looking minutes through the rate-calculation engine and note where the breakpoints occur.

### C. The Validations of the Embodiments of the Present Invention

To handle validations that may occur subsequent to entry, validations would also need to be encoded. Validations most typically are reductions in the price, which are easily computed, but can also be time-off wherein exit device simply counts back a given number of minutes, and at their most complex mode involve a rate-structure change requiring both the normal and validation rate breakpoints to be encoded on the on-line bar-coded ticket of the embodiments of the present invention.

### D. A Validation Example of the Embodiments of the Present Invention

Follows is an example of information on the on-line bar-coded ticket of the embodiments of the present invention showing (1) money-off, (2) time-off, and (3) rate change:

| | | |
|---|---|---|
| | | VALUE (10-BYTES |
| VALIDATION-ID | TYPE | UNCOMPRESSED) |

| | | |
|---|---|---|
| 0001 | 1 | 010.00, i.e., up to $10 off a |
| | | fee |
| 0002 | 2 | 1440, i.e., up to 1,440 |
| | | minutes (one day) free |
| 0003 | 3 | 0002, i.e., compute fee |
| | | using alternate rate-2 |

### E. The Storage Requirements of the Embodiments of the Present Invention

It is estimated that at a minimum 6K-bytes of information can be stored on a standard parking ticket using 2-D bar coding. Assuming 15-bytes of storage to encode each price breakpoint, 400 breakpoints could be encoded. Estimating that most rate structures have no more than 20 breakpoints per day and 50 validations, to record breakpoints and validations for a 2 week period would require:

(14*20*15)+(50*10)=4,500 bytes of storage occupying 78% of available space

### F. The Advantages of the Embodiments of the Present Invention

The on-line bar-coded ticket of the embodiments of the present invention include a fault-tolerant, on-line revenue system and reduced-footprint, unconnected exit devices, e.g., handheld fee computer.

An on-line transient parking system becomes more robust because rather than requiring both the entrance and the exit devices to be on-line to the server, instead either the entrance or the exit device can be on-line. On entrance, normally the on-line bar-coded ticket of the embodiments of the present invention is created using rate information provided by the server, however, if the server is unreachable, the entrance device will not create the on-line bar-coded ticket of the embodiments of the present invention, but instead simply encode the entrance time on a standard ticket. When the standard ticket is presented to the exit device, it can compute the fee from the server as is typical with the on-line transient parking operation. Conversely, the exit device can tolerate any amount of server downtime as long as the on-line bar-coded tickets of the embodiments of the present invention are presented.

The on-line bar-coded ticket of the embodiments of the present invention allows for the design of exit devices having no connectivity and requiring no ability to compute fees. An example would be a handheld PC utilized as a POS device. This could be deployed without requiring the handheld's to be continuously networked.

The on-line bar-coded ticket of the embodiments of the present invention is no more or less vulnerable to a mutilated ticket than other technologies, and fraudulently counterfeiting the 2-D bar code is not likely due to the small size, high density and integrity checks utilized by the encoding technologies.

### G. THE CONCLUSIONS

It will be understood that each of the elements described above or two or more together may also find a useful application in other types of constructions differing from the types described above.

While the embodiments of the present invention have been illustrated and described as embodied in an on-line bar-coded ticket for transient parking, which requires a server connection only at either entrance or exit, but not both, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. An on-site system for calculating a transient parking fee, comprising:
a) a ticket; and
b) a machine-readable storage device;
wherein said machine-readable storage device is disposed on said ticket;
wherein said machine-readable storage device is machine-readable from said ticket; and
wherein said machine-readable storage device contains data necessary to compute the transient parking fee at exit of the transient parking without any further need to utilize a rate calculation engine.

2. The system of claim 1, wherein said machine-readable storage device is a bar code.

3. The system of claim 1, further comprising a server; and
wherein said server communicates with said machine-readable storage device.

4. The system of claim 3, wherein said server has a rate structure;
wherein said rate structure of said server includes breakpoint times; and
wherein said server looks forward from an entrance date and time to determine said breakpoint times by minutes where there is a change in a fee and then encodes that data onto said machine-readable storage device on said ticket.

5. The system of claim 4, wherein said breakpoint times of said rate structure of said server include:
a) a grace period;
b) a first hour fee;
c) each additional hour fee; and
d) a daily maximum fee.

6. The system of claim 5, wherein said rate structure of said server includes:
a) an early-bird fee;
b) a night-rate fee; and
c) a weekend rate fee.

7. The system of claim 4, wherein said server once per minute runs a given period of forward-looking minutes through a rate-calculation engine and notes where said breakpoint times occur.

8. The system of claim 6, wherein said rate structure of said server further includes validations occurring subsequent to the entrance date and time; and
wherein said validations of said rate structure of said server are encoded in said machine-readable storage device on said ticket.

9. The system of claim 8, wherein the validations of said rate structure of said server include:
a) a reduction in price;
b) a time-off; and
c) a rate change.

10. The system of claim 1, wherein said machine-readable storage device requires 4,500 bytes of storage occupying 78% of available space of said ticket.

11. The system of claim 1, further comprising:
a) an entrance device; and
b) an exit device;
wherein either said entrance device or said exit device must be on-line, but not both.

12. The system of claim 11, wherein said exit device is a handheld fee computer utilized as a POS device; and
wherein said handheld fee computer is a network-unconnected exit device.
